(19) United States
(12) Patent Application Publication
(10) Pub. No.: US 2012/0079279 A1
(43) Pub. Date: Mar. 29, 2012

(54) Generation of SW Encryption Key During Silicon Manufacturing Process

(75) Inventor: Maxime Leclercq, Encinitas, CA (US)

(73) Assignee: MaxLinear, Inc., Carlsbad, CA (US)

(21) Appl. No.: 13/075,038

(22) Filed: Mar. 29, 2011

Related U.S. Application Data
(60) Provisional application No. 61/372,390, filed on Aug. 10, 2010.
(60) Provisional application No. 61/319,198, filed on Mar. 30, 2010.
(60) Provisional application No. 61/318,744, filed on Mar. 29, 2010.

(51) Int. Cl. H04L 9/08

(52) U.S. Cl. 713/187; 380/282; 713/189

(57) ABSTRACT

A method of generating an encryption key during the manufacturing process of a device includes randomly generating a seed, encrypting a unique identifier disposed in the device to obtain a first encryption key, encrypting the first encryption key using a public key to obtain a second encryption key, and sending the second encryption key and the seed to a software provider. The method further includes receiving the second encryption key and the seed by the software provider and decrypting the second encryption key using a private key to recover the first encryption key. The manufacturer then encrypts a program code using the recovered first encryption key and installs the seed in a certificate that is associated with the encrypted program code.

### CROSS-REFERENCES TO RELATED APPLICATIONS

The present application claims benefit under 35 USC 119(e) of the following US applications, the contents of all of which are incorporated herein by reference in their entirety:
U.S. application No. 61/318,744, filed Mar. 29, 2010, entitled “Generation of SW Encryption Key During Silicon Manufacturing Process”;
U.S. application No. 61/319,198, filed Mar. 30, 2010, entitled “Control Word Obfuscation in Secure TV Receiver”; and
U.S. application No. 61/372,390, filed Aug. 10, 2010, entitled “Control Word Obfuscation in Secure TV Receiver”.

The present application is related to and incorporates by reference the entire contents of the following US applications:
U.S. application Ser. No. 13/021,178, filed Feb. 4, 2011, entitled “Conditional Access Integration in a SOC for Mobile TV Applications”;
U.S. application Ser. No. 13/026,000, filed Feb. 11, 2011, entitled “RAM Based Security Element for Embedded Applications”;
U.S. application Ser. No. 13/041,256, filed Mar. 4, 2011, entitled “Code Download and Firewall for Embedded Secure Application”; and
U.S. application Ser. No. 13/072,069, filed Mar. 25, 2011, entitled “Firmware Authentication and Deciphering for Secure TV Receiver”.

### BACKGROUND OF THE INVENTION

The present invention relates to cryptography. More particularly, the present invention relates to a method and system for generating encryption keys and communicating the encryption keys to a recipient during the manufacturing process.

Various contents such as movies, music, game software, sport events, and others are offered by service providers through a variety of wired and wireless communication networks. Some of these contents are encrypted so that they can be accessed or viewed by subscribers who are in possession of a corresponding decryption key. It is understandable that service providers will try to protect their software and devices from tampering during the fabrication. Embodiments of the present invention provide methods and systems of securely communicating encryption keys during the manufacturing process.

In general, when a firmware vendor or a component manufacturer produces firmware or hardware that can perform deciphering functions on their encrypted information services, the firmware vendor or the component manufacturer randomly generates encryption keys and program those encryption keys into their products. However, if the encryption keys are required to be sent to a recipient such as an end-product manufacturer, the encryption keys may be intercepted by “hackers” or “malicious users.”

Therefore, there is a need for a method and system of generating encryption keys and securely communicating them to a remote recipient (e.g., an end-product manufacturer).

### BRIEF SUMMARY OF THE INVENTION

Embodiments of the present invention provide a method of generating an encryption key during the manufacturing process of a device. The method includes randomly generating a seed value, encrypting a unique identifier disposed in the device to obtain a first encryption key, encrypting the first encrypting key using a public key to obtain a second encryption key, and sending the second encryption key and the seed value to a manufacturer.

In an embodiment, the method may further include receiving the second encryption key and the seed value by the manufacturer, and decrypting the second encryption key to obtain the first encryption key using a private key. In an embodiment, the seed value is randomly generated by the device.

In an alternative embodiment, a method of generating an encryption key during the manufacturing process of a device includes randomly generating a seed value, randomly generating a unique identifier, programming the unique identifier in a non-volatile register disposed in the device, encrypting the unique identifier using the seed value to obtain a first encryption key, encrypting the first encryption key using a public key to generate a second encryption key, and sending the second encryption key and the seed value to a recipient.

In an embodiment, the seed value is randomly generated externally to the device. In an embodiment, the method may further include decrypting the second encryption key by the recipient to recover the first encryption using a private key. In an embodiment, the recipient may encrypt a program code using the recovered first encryption and installs the received seed value into a certificate that is associated with the encrypted program code.

Embodiments of the present invention also disclose a system including a random number generator for generating a first seed, a non-volatile memory register containing a unique identifier, an interface unit for receiving a public key, and a processing unit that is operative to encrypt the unique identifier using the first seed to obtain a first key, encrypt the first key using the public key to obtain a second key, and output the second key and the seed value.

Other embodiments, features and advantages of the present invention may be more apparent upon review of the specification and the claims to follow.

### BRIEF DESCRIPTION OF THE DRAWINGS

Preferred embodiments of the present invention are described below, by way of example only, with reference to the accompanying drawings, in which:

FIG. 1 is a simplified schematic block diagram of an electronic device that generates encryption keys according to an embodiment of the present invention;

FIG. 2 a flow diagram of an example method of generating an encryption key and securely communicating the encryption key to a recipient according to an embodiment of the present invention;

FIG. 3 is a flow diagram of an example method of generating an encryption key and securely communicating the encryption key to a recipient according to an alternative embodiment of the present invention;

FIG. 4 is a simplified block diagram illustrating a process of generating an encryption key and a seed during the manufacturing process of a device (e.g., demodulator SOC, digital receiver) according to an embodiment of the present invention;

FIG. 5 is a block diagram illustrating a receiver performing a firmware image download operation from an external memory device according to an embodiment of the present invention; and

FIG. 6 is an exemplary process of decrypting or deciphering a firmware stored in the secure RAM according to an embodiment of the present invention.

### DETAILED DESCRIPTION OF THE INVENTION

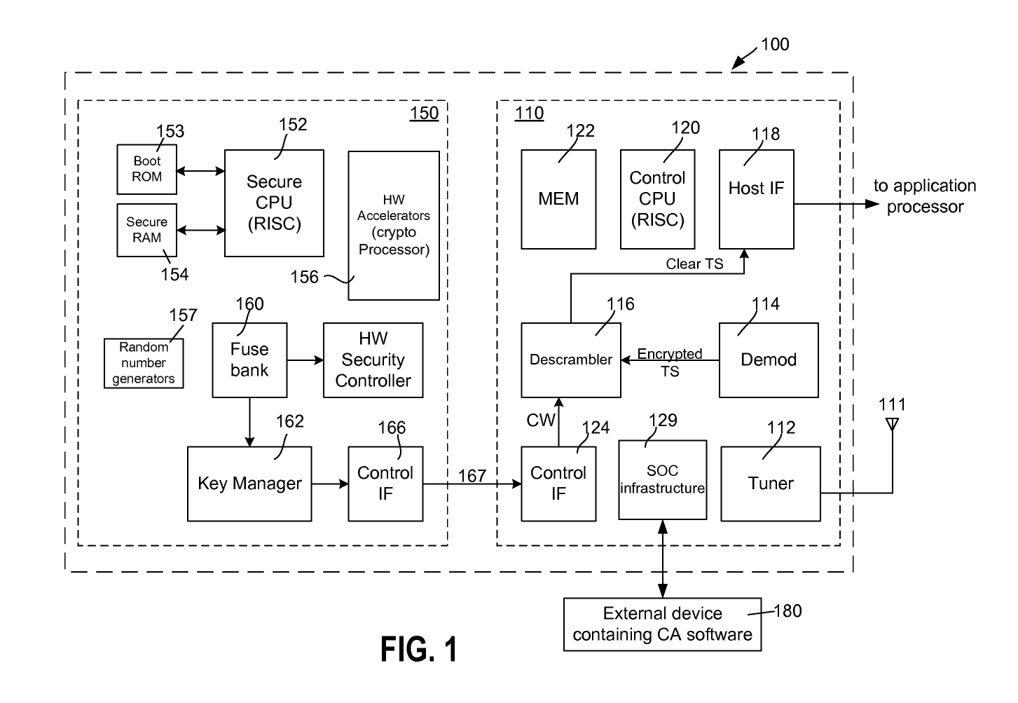

FIG. 1 is a simplified block diagram of an exemplary electronic device, for example, a conditional access device. Conditional access (CA) is used by TV broadcasters to generate revenue. To achieve this, security guidelines are used to protect the keys provisioned to the user and to guarantee that no hacker or malicious entity can crack the system and watch contents for free. These guidelines, also referred to as security requirements, define methods adapted to prevent misuse of the conditional access device and its associated firmware, and furthermore to inhibit unauthorized access to secret keys, operating modes, etc. For purposes of illustration and not limitation, electronic device 100 is represented as a digital broadcast receiver 100 that may be capable of receiving encrypted information data transmitted by a service provider. Digital broadcast receiver 100 includes a demodulation logic 110 and an integrated secure element 150 according to an embodiment of the present invention. Demodulation logic 110 may include a tuner 112, a demodulator 114, a descrambler 116, a control CPU 120, a memory unit 122 that may comprise RAM and/or ROM, a host interface 118, and a first control interface unit 124. Tuner 112 is shown as coupled to an antenna 111. Although an antenna is shown, antenna 111 may include any number of antennas configured to suit different frequency bands of interest. Tuner 112 converts the received radio frequency signals into baseband signals and provides them to demodulator 114 that demodulates them into multiple data streams (audio, video, text, messages, etc.) that may be encrypted (indicated as “Encrypted TS”). Descrambler 116 deciphers the encrypted data streams and provides clear data streams to host interface 118. Demodulator logic 110 may further include system-on-a chip (SOC) infrastructure 129 such as registers, IO ports, a memory interface link that is coupled to an external device 180. In an embodiment, external device 180 may contain a Flash memory storing firmware that is designated for the digital broadcast receiver. Memory interface link 180 may include a physical connection such as a SD card connector, a USB connector, an optical (e.g., infrared), or radio wave (e.g., Bluetooth, wireless LAN IEEE802.11, or the like) communication link.

In an embodiment, integrated secure element 150 includes a secure CPU 152, a read-only memory (ROM) 153 containing a boot code, a secure random access memory (RAM) 154, one or more hardware accelerators 156, one or more random number generators 157, multiple non-volatile memory registers (e.g., one-time programmable fuse banks) 160. CPU 152 may include an adder and logic for executing arithmetic operations or comparative decisions. In an embodiment, the non-volatile memory registers are implemented using fuse cells that can be fabricated using standard CMOS processes. In an embodiment, the non-volatile memory registers are programmed (burned or blown) during the silicon manufacturing process to store information such as the device ID, the root public key, and others. Integrated secure element 150 further includes a key management unit 162 that generates control words and securely communicates the control words to descrambler 116 through a control interface unit 166 and a secure link 167. In an embodiment, secure CPU 152 may also perform the functions of the one or more random number generators 157 and generate random numbers that are used to generate encryption keys. The generation of encryption keys will be described in detail below.

In order to minimize cost, the CA software code is stored in the secure RAM 154 according to an embodiment of the present invention. CA software is understood as instructions, one or more sets of instructions, data files, firmware, or executable applications that are provided to the secure CPU 152 for execution. In an embodiment, CA software is dynamically downloaded from the external device 180 to secure RAM 154 during the power cycle of the integrated secure element 150. Because CA software is downloaded from the external device, it must be first authenticated by the integrated secure element 150. In an embodiment, the secure element operates a protocol to authenticate the CA software using a public key algorithm and a digital certificate (e.g., a unique device ID) that is provided during the manufacturing of the demodulator SOC. In an embodiment, the authentication process can be assisted and accelerated using one or more hardware accelerators 156.

In an embodiment, CA software is received by SOC infrastructure 129 from the external device and transferred to the secure RAM 155. Because the external device containing the CA software is outside the security perimeter of the secure element, it must first be authenticated. In an embodiment, the downloaded CA software is authenticated by the secure element running boot authenticate programs from boot ROM 153.

In an embodiment, the integrated secure element executing CA software produces a control word and provides the control word to the demodulator logic for descrambling the received data streams. In some embodiments, the control word can be a secure bit pattern to enable the descrambling process in the demodulator logic 110.

In an embodiment, the integrated secure element 150 is activated when the TV application is enabled by the user. When the TV application is enabled, the demodulator logic causes the boot ROM to execute the boot instructions and activate the integrated secure element. During the boot process, the conditional access (CA) software stored in the external device is downloaded to the RAM disposed in the secure element.

As described above, the remote device contains conditional access (CA) software, i.e., executable applications or data files that are dynamically loaded to the RAM 154 disposed in the integrated secure element. In an embodiment, the external device contains a digital certificate that is generated by the CA vendor, the demodulator SOC device manufacturer and signed with the root private key or a derivative of the root key using public key infrastructure (PKI). In an embodiment, the digital certificate may be unique to each demodulator SOC device and contains a device identification (ID) code. In an embodiment, the same identification code may also be stored in one or more of the non-volatile registers 160. In an embodiment, the non-volatile memory registers 160 may also store a digital signature of the CA software. In an embodiment, the boot ROM authenticates the CA firmware by means of the digital certificate.

In an embodiment, the secure boot ROM may process the digital certificate as follows: (i) verify that the certificate is authentic and the certificate has been signed by a trusted delegate of the root key owner; (ii) verify that the certificate is intended for the given device by comparing the device ID stored in the secure element NVM (non-volatile memory) registers and the code stored in the certificate to ensure that they match; and (iii) authenticate the firmware by regenerating its signature with the root public key and comparing the result with the value stored in the certificate. Only when the above three steps are successful, the SW that has been downloaded to the secure element RAM is verified and considered to be trustworthy. In an embodiment, the SW code in the external memory may be encrypted. In this case, it is first deciphered by the boot ROM. The SW encryption key (or a derivative) is stored in the secure element NVM registers and used directly by the ROM code.

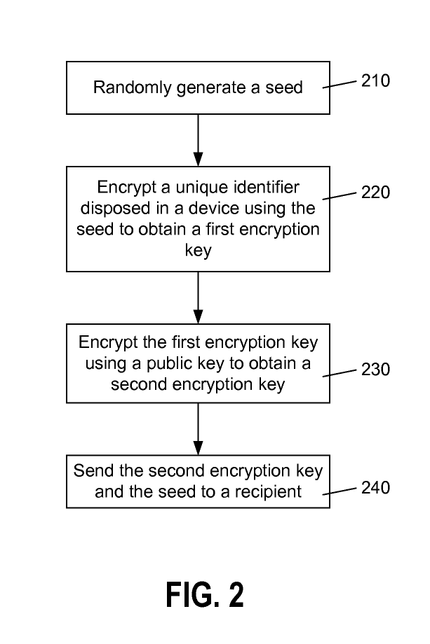

FIG. 2 is a flow diagram of an example method of generating an encryption key and securely communicating the encryption key to a trusted recipient according to an embodiment of the present invention. In step 210, the method randomly generates a seed at a service provider. In an embodiment, the seed can be generated from a random number generator that is disposed on digital broadcast receiver 100 of FIG. 1. In step 220, the method encrypts an identifier that is unique to the digital broadcast receiver using the seed to obtain a first encryption key. In an embodiment, the unique identifier is stored in the non-volatile memory register or fuse bank 160 of the device, the non-volatile memory register that contains the unique identifier is safeguarded in a secure area that is not accessible to a user in any modes, i.e., it is not accessible whether the device is in normal operation mode, in a built-in self-test mode, or in a scan mode. The method further encrypts the first encryption key using a public key of the trusted recipient to obtain a second encryption key in step 230. The method then sends the second encryption key and the seed to the trusted recipient in step 240. The recipient may be the CA software provider, an original design manufacturer (ODM), or a original equipment manufacturer (OEM). The objective is to provide the CA software vendor the “key” to encrypt the CA software. In an embodiment, the “identifier” is unique to each device and must be “burned” in the non-volatile memory register of the device. Once the “identifier” is generated, then the CA software vendor can encrypt a batch of CA software with that “identifier” and the encrypted CA software will then work only with the intended device.

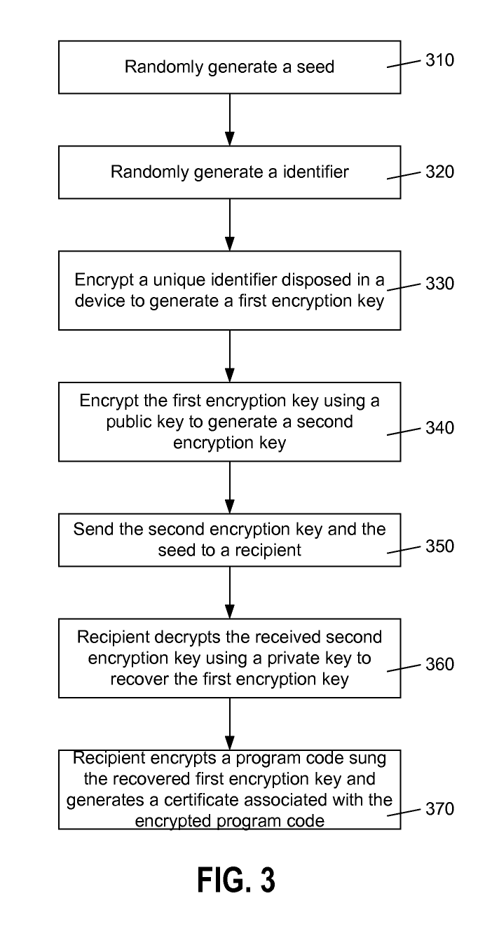

FIG. 3 is a flow diagram of an example method of generating a seed and an encryption key and securely communicating the generated encryption key to a recipient according to an alternative embodiment of the present invention. In step 310, the method randomly generates a seed. In an embodiment, the seed can be generated externally to the digital broadcast receiver. In step 320, the method randomly generates a number that should be sufficient large to provide a unique identifier and stores the identifier in a non-volatile memory register of the digital broadcast receiver. The method encrypts the identifier using the seed to generate a first encryption key in step 330 and encrypts the first encryption key using a public key to generate a second encryption key in step 340. The method then sends the second encryption key together with the seed to a recipient that can be the CA software provider, an OEM vendor in step 350. Recipient receives the second encryption key and the seed and recovers the first encryption key by encrypting (decrypting) the received second encryption key using a private key in step 360. Recipient then encrypts a program code that can be a conditional access software that is provided to the digital broadcast receiver. Recipient also installs the received seed into a certificate that is associated with the encrypted program code. It should be appreciated that the recipient is a trusted partner of the device manufacturer and has been trusted with the public/private key pair that is unique to the recipient.

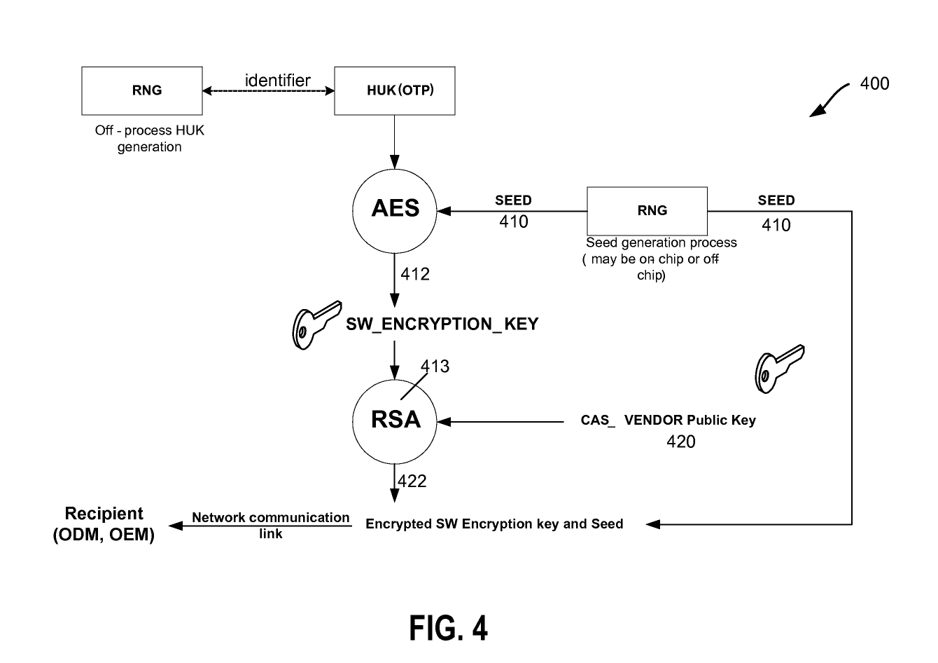

FIG. 4 is block diagram illustrating a process 400 of generating an encryption key during the manufacturing process of a device (e.g., digital broadcast receiver) according to an embodiment of the present invention. In an example embodiment, process 400 generates a device-specific identifier based on a secret random-generated number in a secure and controlled environment at the device manufacturer. The secret random-generated number is programmed to the device in a tamper-resistant register, e.g., a non-volatile memory register or a fuse (one-time programmable) register of the device. This is indicated as the hardware unique key HUK shown in FIG. 4. HUK is then provided to an encryption engine AES that can be one of the hardware accelerators 156 in FIG. 1. Although AES is shown, the encryption engine is not limited to AES and may perform DES or 3DES and other equivalent symmetric encryption algorithms. A seed 410 is also provided to the AES engine for encrypting the device-specific hardware unique key. In an embodiment, seed 410 can be generated by a random number generator that may be one of the on-chip random number generators 157 or in software, hardware, or a combination thereof. In another embodiment, the seed may be generated off-chip. The encryption engine AES generates a first encryption key 412 that is provided to a second encryption engine RSA 413. In an embodiment, second encryption engine RSA 413 may be one of the on-chip hardware accelerators of the device and performs an RSA algorithm that specifies a public key and a private key. The public and private keys are used for encryption and decryption, respectively. Typically, the RSA process is associated with a corresponding PKI (Public Key Infrastructure). Second encryption engine RSA 413 generates a second encryption key 422 using a device vendor public key 420. Second encryption key 422 and seed 410 are then transmitted to a remote recipient 450 (e.g., an ODM or OEM) through a network communication link. In an embodiment, recipient 450 may be a conditional access firmware vendor/manufacturer that installs encrypted firmware into a flash memory device before distributing the encrypted firmware to end users.

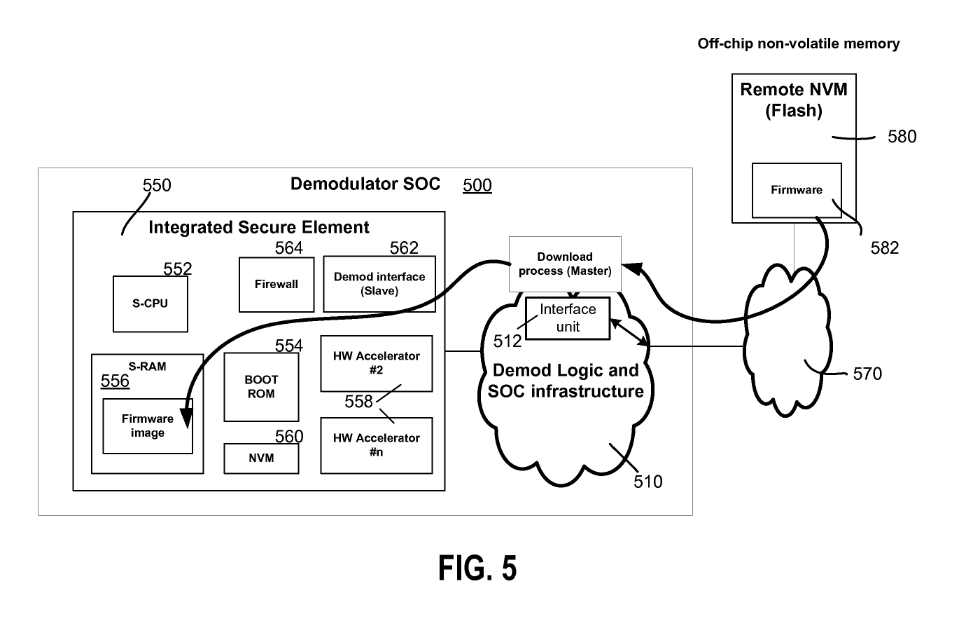

FIG. 5 is a block diagram illustrating a receiver performing a firmware image download operation from the flash memory device 580 according to an embodiment of the present invention. Receiver 500 comprises a demodulator logic 510 and an integrated secure element 550. Demodulator logic 510 may include a tuner, a demodulator, a descrambler, control CPU, a memory unit, a host interface as shown in FIG. 1. The demodulator logic may include SOC infrastructure having one or more IO ports, a memory interface unit, and others. In an exemplary embodiment, the SOC infrastructure may include an interface unit 512 such as a USB, a peripheral computer interface (PCI), a SD (secure digital) interface, or a communication link for interfacing with the off-chip flash memory device 580. In a specific embodiment, the interface unit 512 may establish a connection to the remote memory via a short distance physical connection by means of a USB connector, an SD connector, or the like. In another embodiment, the interface unit 512 may coupled to the remote memory 880 via a local area network, a personal area network (Bluetooth) or a wireless area network according to the IEEE802.11 standard or the like (the local, personal, or wireless area network is indicated as a cloud 870).

The integrated secure element includes a secure CPU 552 that together with a boot ROM 554 initiates the integrated secure element at power up. The secure element further includes a secure static random access memory (S-RAM) 556, one or more hardware accelerators 558, one or more non-volatile memory (NVM) registers or fuses (one-time programmable) 560, and a slave demodulator interface circuit 562 that couples the integrated secure element 550 with the demodulator logic 510.

The secure element may include a firewall 564 that allows for the secure CPU to initiate a connection to the remote memory 580 and download firmware (i.e., data files, executable applications) 582 from the remote memory to the secure S-RAM 556, but does not allows the remote memory to initiate a connection in the reverse direction. It should be appreciated that the demodulator logic cannot access the secure element through the master-slave demodulator interface 562 once the security element is locked.

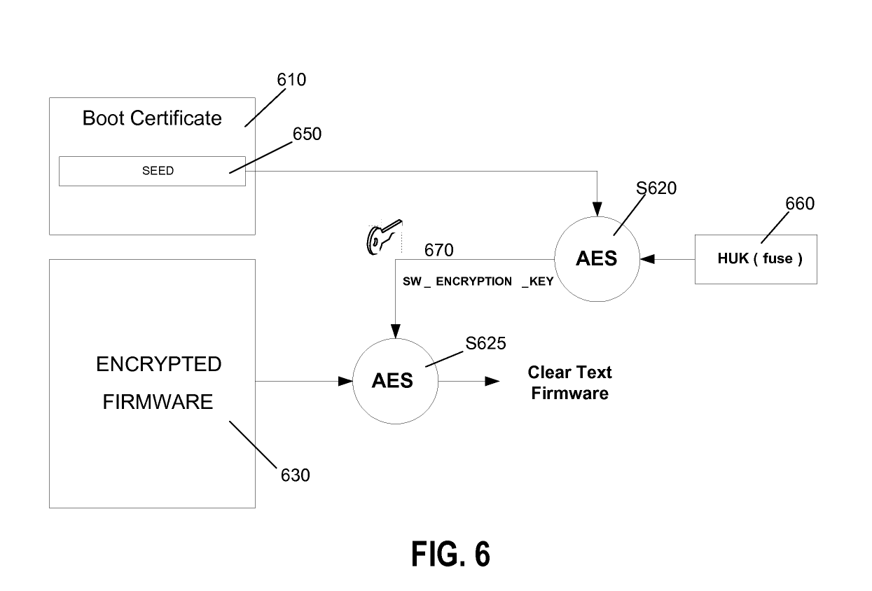

FIG. 6 is an exemplary process of decrypting or deciphering a firmware stored in the secure RAM according to an embodiment of the present invention. The decryption process is optional and is only needed when the stored firmware has been previously received in an encrypted form. To decipher the encrypted firmware 630, the secure element first retrieves a SEED 650 disposed in a boot certificate 610 that has been validated and thus considered to be authentic and encrypts the SEED using a unique device key 660 (Hardware unique key that is unique and private per device and stored in a non-volatile memory register). The thus generated software encryption key 670 at step S620 is then used to decipher the encrypted software 630 at step S625.

In an embodiment, a software vendor uses the retrieved encryption key to encrypt CA firmware before distributing the encrypted firmware to target subscribers. The encrypted firmware is accompanied with an associated certificate containing the seed, as shown in FIG. 6.

It is understood that the above embodiments of the present invention are illustrative and not limitative. Various alternatives and equivalents are possible. The invention is not limited by the type of integrated circuits in which the present disclosure may be disposed. Other additions, subtractions or modifications are obvious in view of the present invention and are intended to fall within the scope of the appended claims.

What is claimed is:

1. A method of generating an encryption key during the manufacturing process of a device, the method comprising:
randomly generating a seed value;
encrypting a unique identifier disposed in the device using the seed value to obtain a first encryption key;
encrypting the first encryption key using a public key to obtain a second encryption key; and
sending the second encryption key and the seed value to a software provider.

2. The method of claim 1, wherein the seed value is randomly generated by the device.

3. The method of claim 1 further comprising:
receiving the second encryption key and the seed value by the software provider; and
decrypting the second encryption key to obtain the first encryption key.

4. The method of claim 3, wherein the decrypting the second key comprises using a private key that forms with the public key a public/private key pair.

5. The method of claim 3, wherein the software provider encrypts a program code using the first encryption key and generates a certificate associated with the encrypted program code, the certificate including the seed value.

6. The method of claim 5 further comprising:
receiving the encryption program code and the associated certificate by the device; and
reproducing the program code using the seed value stored in the certificate and the unique identifier.

7. The method of claim 6 further comprising:
authenticating the certificate prior to reproducing the program code.

8. The method of claim 1, wherein the unique identifier is generated in the device.

9. The method of claim 1, wherein the unique identifier is not accessible to a user even in a test mode.

10. A method of generating an encryption key during the manufacturing process of a device, the method comprising:
randomly generating a seed value;
randomly generating a unique identifier;
programming the unique identifier in a non-volatile register disposed in the device;
encrypting the unique identifier to generate a first encryption key;
encrypting the first encryption key using a public key to generate a second encryption key; and
sending the second encryption key and the seed value to a recipient.

11. The method of claim 10, wherein the seed value is randomly generated externally to the device.

12. The method of claim 10, wherein the unique identifier is generated externally to the device.

13. The method of claim 10 further comprising:
receiving the second encryption key and the seed value by the manufacturer; and
decrypting the second encryption key to obtain the first encryption key.

14. The method of claim 13, wherein the decrypting the second key comprises using a private key that forms with the public key a public/private key pair.

15. The method of claim 13, wherein the recipient encrypts a program code using the first encryption key and generates a certificate associated with the encrypted program code, the certificate including the seed value.

16. The method of claim 15 further comprising:
receiving the encryption program code and the associated certificate by the device; and
reproducing the program code using the seed value stored in the certificate and the unique identifier.

17. The method of claim 16 further comprising authenticating the certificate prior to reproducing the program code.

18. A system comprising:
a random number generator for generating a first seed;
a non-volatile register having a unique identifier;
an interface unit configured to receive a public key;
a processing unit operative to:
encrypt the unique identifier using the first seed to obtain a first key;
encrypt the first key using the public key to obtain a second key; and
output the second key and the seed value.

19. The system of claim 18 further comprising a demodulator configured to receive an encrypted program code including a certificate, wherein the certificate contains a second seed.

20. The system of claim 19, wherein the processing unit is operative to:
generate an encryption key using the unique identifier and the second seed contained in the certificate; and
decipher the encrypted program code using the encryption key.
